(19) United States
(12) Patent Application Publication
(10) Pub. No.: US 2023/0072764 A1
(43) Pub. Date: Mar. 9, 2023

(54) LITHIUM-CONTAINING SILICON OXIDE COMPOSITE ANODE MATERIAL, METHOD FOR PREPARING SAME, AND LITHIUM ION BATTERY

(71) Applicant: Guangdong Kaijin New Energy Technology Co., Ltd., Dongguan (CN)

(72) Inventors: Rusheng Fu, Dongguan (CN); Fuhai Cao, Dongguan (CN); Dexin Yu, Dongguan (CN); Yongjun Yang, Dongguan (CN)

(73) Assignee: Guangdong Kaijin New Energy Technology Co., Ltd., Dongguan (CN)

(21) Appl. No.: 17/535,680

(22) Filed: Nov. 25, 2021

(30) Foreign Application Priority Data
Sep. 8, 2021 (CN) 202111050036.7

(51) Int. Cl. C01D 15/02; H01M 10/0525

(52) U.S. Cl. CPC C01D 15/02; H01M 10/0525; C01P 2004/84; C01P 2002/72

(57) ABSTRACT

A lithium-containing silicon oxide composite anode material has a core-shell structure which includes a core and a shell. The core includes nano-silicon, Li₂SiO₃ and Li₂Si₂O₅, and the shell is a conductive carbon layer wrapping the core. The invention provides a lithium-containing silicon oxide composite anode material which is able to maximize the reversible capacity and has a long cycle life, and a lithium ion battery containing the lithium-containing silicon oxide composite anode material. The invention further provides a method for preparing a lithium-containing silicon oxide composite anode material, which is simple in process, environmentally friendly and free of pollution.

### FIELD

The invention relates to the field of anode materials for lithium batteries, in particular to a lithium-containing silicon oxide composite anode material, a method for preparing the same, and a lithium ion battery.

### BACKGROUND

At present, commercial lithium ion batteries typically adopt graphite anode materials that have a theoretical specific capacity of 372 mAh/g, which cannot meet the requirement for high energy density of lithium ion batteries in the future. Emerging Si anodes have a high theoretical specific capacity (4200 mAh/g), thus having become one of the most promising alternative anode materials. However, the volume expansion ratio of Si anodes reach upto 300%, so silicon particles are prone to breakage and pulverization during the charge-discharge processes, which leads to repeatedly crack and regeneration of SEI films, causing excessive consumption of electrolyte and dramatic reduction of the cycle performance. In addition, silicon oxide anode materials have a specific capacity of about 2000 mAh/g and a relatively low volume expansion ratio, which is 148%. In the first charge-discharge process of the silicon oxide anode materials, irreversible lithium-containing compounds such as lithium silicate and lithium oxide will be formed after a large number of lithium ions are intercalated, which leads to irreversible wastage of these lithium ions, resulting in low initial coulombic efficiency which is generally less than 75%. The most effective approach to improve the initial efficiency of the silicon oxide anode materials is to pre-dope the materials with lithium to remove irreversible lithium in the silicon-oxygen materials by reaction in advance. An existing industrially feasible method is to directly coat the surface of anodes with a lithium coating to reduce the wastage of positive lithium ions of a full battery system. However, this method puts forward high requirements for the operating environments and has potential safety hazards, and thus cannot be widely popularized. In the prior art, it is an effective approach to obtain products with high initial charge-discharge efficiency by pre-lithiating the ends of the silicon oxide materials.

In the prior art, a method for pre-lithiating silicon oxide materials is disclosed, and comprises: (1) coating a silicon oxide with carbon by CVD; and (2) allowing carbon-coated powder to be subjected to a solid-phase reaction with lithium hydride to form a pre-lithiated silicon oxide anode material containing Li₂SiO₃, Li₄SiO₄, Li₂Si₂O₅ and Si. In addition, a method for preparing a lithium-containing silicon oxide anode material by thermal doping of lithium is disclosed, wherein a large amount of lithium silicates, nano-silicon, Li2O and Li—Si alloy are formed in a silicon oxide after pre-lithiation, and the lithium silicates may be of different forms such as Li₄SiO₄, Li₂SiO₃, Li₂Si₂O₅ and Li₂Si₃O₇. Generally, aqueous paste prepared from the silicon oxide anode material modified by lithium doping generates too much gas, which results in pinholes after anodes are dried; and the aqueous paste is highly alkaline and poor in processability.

In one aspect, lithium silicates may be slowly dissolved in water to form a strongly alkaline solution, and the solubility of lithium silicates in water depends on the modulus of the lithium silicates, which may be expressed as Li₂O.nSiO₂, wherein n represents the modules, and the greater the value of n, the lower the solubility of the lithium silicates in water. Chinese Invention Patent Publication No. CN110970600A discloses a method for preparing a composite anode material containing a high-modulus lithium silicate Li₂O.1.5SiO₂ (Li₆Si₂O₇), Li₂O.2SiO₂ (Li₂Si₂O₅) or Li₂O.5SiO₂ (Li₂Si₅O₁₁), wherein the high-modulus lithium silicate can improve the structural stability of the material to obtain good cycle stability. Also disclosed in the prior art is a lithium-containing silicon oxide anode material containing Li₂Si₂O₅ (Li₂O.2SiO₂) coated with other lithium silicates, which solves the problem of strong alkalinity generated after pre-lithiation of anode materials in the prior art and processing problems caused by by-products dissolved in water.

Also disclosed in the prior art is a lithium-containing silicon oxide anode material only containing one lithium silicate Li₂Si₂O₅ by adding a nucleating additive to effectively convert Li₂SiO₃ into Li₂Si₂O₅. Although the water solubility becomes lower and the aqueous processability of materials becomes better with the increase of the modulus of lithium silicates, more silicon will be consumed under the condition where a unit quantity of lithium is added, so the reversible capacity of the lithium-containing silicon oxide composite material is reduced.

Also, a method for modifying a silicon oxide by co-doping of Li and Mg is disclosed in the prior art to prepare a anode material of a SiOₓ-lithium silicate-magnesium silicate multi-component composite system, wherein the magnesium silicate with high bonding strength is unlikely to be dissolved in water, so that the structural stability of the material and the stability of aqueous paste are improved, and the cycle performance of the material is improved. However, due to the large molar mass of Mg, the modified silicon oxide anode material has a relatively low reversible capacity.

### SUMMARY

To solve the above-mentioned technical problems, the invention provides a lithium-containing silicon oxide composite anode material which is able to maximize the reversible capacity and has a long cycle life, and a lithium ion battery.

The invention further provides a method for preparing a lithium-containing silicon oxide composite anode material, which is simple in process, environmentally friendly and free of pollution.

In one aspect, the present invention provides a lithium-containing silicon oxide composite anode material, wherein the lithium-containing silicon oxide composite anode material has a core-shell structure which comprises a core and a shell, the core comprises nano-silicon, Li₂SiO₃ and Li₂Si₂O₅, and the shell is a conductive carbon layer wrapping the core.

In some embodiments, an average grain size of the nano-silicon is less than or equal to 20 nm.

In some embodiments, a thickness of the conductive carbon layer is 2-500 nm.

In some embodiments, a diffraction peak area of Li₂SiO₃(111) with 2θ being 26.90±0.3° in an XRD spectrum of the lithium-containing silicon oxide composite anode material is A1, and a diffraction peak area of Si(111) with 2θ being 28.40±0.3° in the XRD spectrum is A2; and A2/A1≥1.0.

In some embodiments, a diffraction peak intensity of Li₂Si₂O₅(111) with 2θ being 24.75±0.2° in an XRD spectrum of the lithium-containing silicon oxide composite anode material is I1, a diffraction peak intensity of Li₂SiO₃(111) with 2θ being 26.90±0.3° in the XRD spectrum is I2; and 0.25≤I1/I2≤1.0.

In another aspect, the present invention provides a method for preparing a lithium-containing silicon oxide composite anode material, comprising:

(1) mixing a carbon-coated silicon oxide SiOₓ with a lithium source by a solid-phase mixing method to form a pre-lithiated precursor;

(2) carrying out heat treatment on the pre-lithiated precursor under a vacuum or non-oxidizing atmosphere, and then dispersing and screening the pre-lithiated precursor to realize phase and structure adjustment to form a compound; and

(3) carrying out surface modification on the compound formed in Step (2) to obtain a surface-treated lithium-containing silicon oxide composite anode material.

In some embodiments, in the carbon-coated silicon oxide SiOx, 0.5≤x≤1.6.

In some embodiments, carbon coating of the carbon-coated silicon oxide SiOₓ is any one of gas-phase coating and solid-phase coating.

In some embodiments, in Step (3), the surface modification is washing which comprises: soaking the compound prepared in Step (2) in a solution A; carrying out solid-phase separation after the compound is soaked in the solution A to obtain a solid; washing the solid with a solution B after solid-liquid separation; and drying the solid. The solution A is any one of alcohol, alkaline water dissolved with lithium carbonate, weak acid, water, and a mixed solution thereof, and the solution B is any one of an ether solvent, a ketone solution, a lipid solution, an alcohol solvent, an amine solvent, and a mixed solvent thereof.

In a third aspect, the present invention further provides a lithium ion battery containing the lithium-containing silicon oxide composite anode material described above.

The invention has the following beneficial effects:

The content of active nano-silicon of the lithium-containing silicon oxide composite anode material provided by the invention is high, so that a high reversible capacity is provided, the reversible capacity of the lithium-containing silicon oxide composite anode material is greatly improved, and the cycle life is long. The lithium-containing silicon oxide composite anode material provided by the invention contain Li₂SiO₃ and Li₂Si₂O₅, wherein Li₂Si₂O₅ has a high modulus and is hardly dissolved in water, and Li₂SiO₃ has a low modulus and can be dissolved in water slowly, so the lithium-containing silicon oxide composite anode material is excessively alkaline in the aqueous paste preparation process, and the formation of Li₂Si₂O₅ is more beneficial for improving the water resistance of the lithium-containing silicon oxide composite anode material under the same lithium doping condition; however, the same amount of silicon is consumed during doping of per unit quantity of lithium when Li₂Si₂O₅ is formed, and 50% of silicon is consumed during doping of per unit quantity of lithium when Li₂SiO₃ is formed, which means that the formation of Li₂SiO₃ is more beneficial for maximizing the capacity of the lithium-containing silicon oxide composite anode material under the same lithium doping condition. It is found, by a large amount of comparison and study, that within the proportion range of Li₂SiO₃ and Li₂Si₂O₅ defined in the invention, the lithium-containing silicon oxide composite anode material has a high reversible capacity and good water resistance. The initial reversible capacity of the lithium-containing silicon oxide composite anode material may reach 1600 mAh/g, the initial coulombic efficiency may reach over 91.0%, and the capacity retention rate after 50 cycles may reach 98%. The method provided by the invention is simple, environmentally friendly, free of pollution, and suitable for large-scale industrial production.

### BRIEF DESCRIPTION OF THE DRAWINGS

FIG. 1 is an XRD spectrum of a product in Embodiment 7 of a lithium-containing silicon oxide composite anode material according to the invention;

FIG. 2 is an SEM photograph of the product in Embodiment 7 of the lithium-containing silicon oxide composite anode material according to the invention;

FIG. 3 is an initial charge-discharge curve chart of the product in Embodiment 7 of the lithium-containing silicon oxide composite anode material according to the invention.

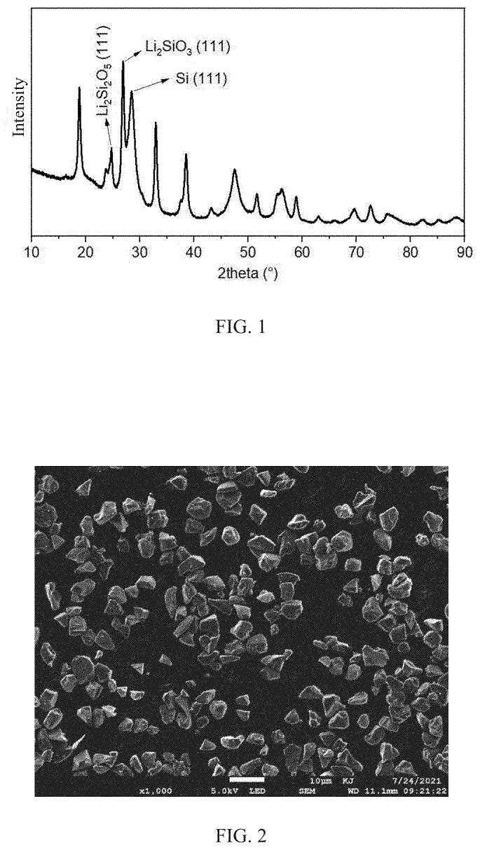

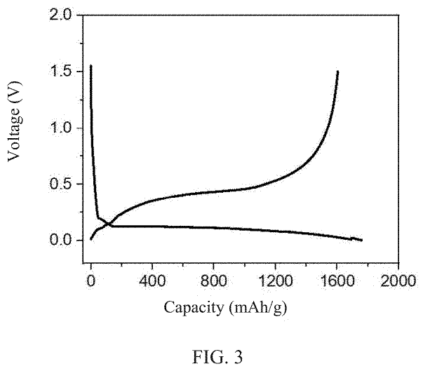

### DESCRIPTION OF THE EMBODIMENTS

To gain a better understanding of the invention, the invention will be further described below in conjunction with embodiments. Clearly, the implementations of the invention are not limited to the following ones.

The invention provides a lithium-containing silicon oxide composite anode material. The lithium-containing silicon oxide composite anode material has a core-shell structure, wherein the core comprises nano-silicon, Li₂SiO₃ and Li₂Si₂O₅, and the shell is a conductive carbon layer wrapping the core. According to the lithium-containing silicon oxide composite anode material, a high reversible capacity is guaranteed by optimizing the relative content of active silicon, and both the reversible capacity and the processability of the material are guaranteed by controlling the relative content of Li₂SiO₃ and Li₂Si₂O₅. The average grain size of silicon particles in the lithium-containing silicon oxide composite anode material is less than or equal to 8 nm, and the small-sized active silicon can effectively restrain structural pulverization of the material in the charge-discharge process and improve the cycle stability of batteries. The diffraction peak area of Li₂SiO₃(111) with 2θ being equal to 26.90±0.3° in an XRD (X-Ray Diffraction) spectrum is A1, the diffraction peak area of Si(111) with 2θ being equal to 28.40±0.3° in the XRD spectrum is A2, and A2/A1≥1.0. The diffraction peak intensity of Li₂Si₂O₅ (I11) with 2θ being equal to 24.75±0.2° in the XRD spectrum is I1, the diffraction peak intensity of Li₂SiO₃(111) with 2θ being 26.90±0.3° in the XRD spectrum is I2, and 0.25≤I1/I2≤1.0.

In the invention, Li₂SiO₃ hardly soluble in water and Li₂Si₂O₅ insoluble in water coexist, wherein the silicon consumption per unit quantity of lithium of Li₂SiO₃ hardly soluble in water is low, so that the reversible capacity of the composite anode material is improved; and Li₂Si₂O₅(Li₂O.2SiO₂) insoluble in water has a high modulus and a lower water solubility, so that lithium silicates are effectively restrained from being dissolved out in the aqueous paste preparation process of the material, and the stability of paste is improved. The lithium-containing silicon oxide composite anode material of the invention has a high nano-silicon content and a greater lithium storage capacity, thus having a high reversible capacity when used as a anode material for lithium ion batteries.

The following technical solutions are preferred ones, and are not restrictive ones of the invention. By adoption of the following preferred solutions, the technical purposes and beneficial effects of the invention can be better fulfilled and realized.

As a preferred technical solution of the invention, the lithium-containing silicon oxide composite anode material comprises nano-silicon, Li₂SiO₃ and Li₂Si₂O₅.

Preferably, the average grain size of the nano-silicon is less than or equal to 20 nm, and is further preferably less than or equal to 8 nm.

The diffraction peak area of Li₂SiO₃(111) with 2θ being equal to 26.90±0.3° in an XRD spectrum of the lithium-containing silicon oxide composite anode material is A1, and the diffraction peak area of Si(111) with 2θ being equal to 28.40±0.3° in the XRD spectrum is A2.

Preferably, A2/A1≥1.0, and further preferably, A2/A1≥1.5.

The diffraction peak intensity of Li₂Si₂O₅(111) with 2θ being equal to 24.75±0.2° in the XRD spectrum of the lithium-containing silicon oxide composite anode material is I1, and the diffraction peak intensity of Li₂SiO₃(111) with 2θ being equal to 26.90±0.3° in the XRD spectrum is I2.

Preferably, 0.25≤I1/I2≤1.0, and further preferably, 0.25≤I1/I2≤0.5.

The lithium-containing silicon oxide composite anode material further comprises a carbon coating which is uniformly distributed on the surface of the lithium-containing silicon oxide composite anode materials.

Preferably, the thickness of the carbon coating is 2-500 nm such as 2 nm, 5 nm, 10 nm, 50 nm, 100 nm, 146 nm, 250 nm, 330 nm, 400 nm or 500 nm, is further preferably 5-200 nm, and is particularly preferably 10-100 nm.

Preferably, with the total mass of the lithium-containing silicon oxide composite anode material being 100 wt %, the mass percent of the carbon coating is 0.5-20 wt % such as 0.5 wt %, 1 wt %, 2 wt %, 2.5 wt %, 5 wt/%, 6 wt %, 7 wt %, 8 wt %, 9 wt %, 10 wt %, 12 wt %, 15 wt % or 20 wt %, and is further preferably 1-10 wt %.

The median particle size of the lithium-containing silicon oxide composite anode material is 2-15 μm such as 4.5 μm, 4.9 μm, 5.2 μm, 6.3 μm, 8.2 μm, 10 μm, 12 μm or 15 μmma, and is further preferably 4-9 μm.

The invention provides a method for preparing a lithium-containing silicon oxide composite anode material, which should not be construed as a limitation of the technical solution of the invention. The method comprises the following steps:

(1) A carbon-coated silicon oxide SiOₓ and a lithium source are mixed by a solid-phase mixing method to form a pre-lithiated precursor;

(2) Heat treatment is carried out on the pre-lithiated precursor in a vacuum or non-oxidizing atmosphere, and then the pre-lithiated precursor is dispersed and screened to realize phase and structure adjustment to form a compound; and

(3) Surface modification is carried out on the compound formed in Step (2) to obtain a surface-treated lithium-containing silicon oxide composite anode material.

As a preferred technical solution of the invention, in the silicon oxide SiO in Step (1), 0.5≤x≤1.6 such as 0.5, 0.7, 0.9, 1.0, 1.2, 1.4 or 1.6, further preferably 0.7-1.2; and the silicon oxide is preferably SiO.

As a preferred technical solution of the invention, carbon coating in Step (1) is any one of gas-phase coating and solid-phase coating.

Preferably, the gas-phase coating comprises the following steps: placing the silicon oxide in a rotary furnace, introducing a protective atmosphere into the rotary furnace, increasing the temperature to 600-1000° C., introducing an organic carbon source gas, keeping the temperature for 0.5-8 h, and then cooling to obtain the carbon-coated silicon oxide.

Preferably, the protective atmosphere is any one or a combination of at least two of a hydrogen atmosphere, a nitrogen atmosphere, a helium atmosphere, a neon atmosphere, an argon atmosphere, a krypton atmosphere and a xenon atmosphere.

Preferably, the organic carbon source gas is hydrocarbon.

Preferably, the hydrocarbon comprises any one or a combination of at least two of methane, ethylene, acetylene and benzene.

Preferably, the solid-phase carbon coating comprises the following steps: mixing the silicon oxide and a carbon source in a mixer at a speed of 300-1500 rpm for 0.5-2 h to obtain a carbon source-containing mixture, then placing the carbon source-containing mixture in a carbonization furnace for carbonization at a temperature of 600-1000° C. for 2-8 h, and then cooling and discharging to obtain the carbon-coated silicon oxide composite material.

Preferably, the carbon source is any one or a combination of at least two of polymers, saccharides, organic acid and asphalt.

In Step (1) of the invention, the lithium source and the carbon-coated silicon oxide are subjected to an oxidation-reduction reaction to generate nano-silicon and lithium-containing compounds in situ, wherein the nano-silicon is uniformly dispersed between the lithium-containing compounds, so that agglomerations of the nano-silicon are effectively reduced, thus reducing volume expansion of the material applied to batteries and improving the cycle life of the batteries.

Preferably, the lithium source in Step (1) comprises any one or a combination of at least two of lithium hydride, lithium alkylide, lithium metal, lithium aluminum hydride, lithium amide, lithium nitride, lithium carbide, lithium silicide and lithium borohydride.

Preferably, in Step (1), the silicon oxide and the lithium source are mixed by mechanical mixing or mechanical blending/fusion.

Preferably, in Step (1), the silicon oxide and the lithium source are mixed under a vacuum atmosphere or an oxidizing atmosphere.

Preferably, with the total mass of the silicon oxide in Step (1) being 100 wt %, the mass of the lithium source is 2-25 wt % such as 2 wt %, 5 wt %, 7 wt/%, 9 wt %, 10 wt %, 12 wt %, 15 wt %, 17 wt %, 19 wt %, 21 wt % or 25 wt %, and is further preferably 3-15 wt %. However, the mass of the lithium source is not limited to the values listed above, and may be other non-listed values within the value range.

Preferably, the temperature of the heat treatment in Step (2) is 300-1000° C. such as 300° C., 450° C., 550° C., 600° C., 700° C., 800° C., 900° C. or 1000° C., and is further preferably 500-800° C.

Preferably, the time of the heat treatment in Step (2) is 1-10 h such as 1 h, 2 h, 2.5 h, 3 h, 4 h, 5 h, 6 h, 7 h, 8 h, 9 h or 10 h, and is further preferably 3-7 h.

Preferably, the temperature rise rate is 0.5-5° C./min such as 0.5° C./min, 1.0° C./min, 2° C./min, 3° C./min, 4° C./min or 5° C./min, and is further preferably 0.5-1.5° C./min.

Preferably, the non-oxidizing atmosphere in Step (2) comprises any one or a combination of at least two of a hydrogen atmosphere, a nitrogen atmosphere, a helium atmosphere, a neon atmosphere, an argon atmosphere, a krypton atmosphere and a xenon atmosphere.

As a preferred technical solution of the invention, the surface modification in Step (3) is washing, and the compound prepared in Step (2) is soaked in a solution A to remove active lithium from the surface of lithium-containing silicide particles. The solution A may be, such as, alcohol, alkaline water dissolved with lithium carbonate, weak acid, water, and a mixed solution thereof.

Furthermore, after being soaked in the solution A, solid-liquid separation is carried out by centrifugation, extraction filtration or filter pressing.

Furthermore, after solid-liquid separation, washing is carried out with a solution B, wherein the solution B may be an ether solvent, a ketone solvent, a lipid solvent, an alcohol solvent, an amine solvent, or a mixed solvent thereof.

Furthermore, the solid obtained after solid-liquid separation is dried. A drying atmosphere is a vacuum atmosphere or a non-oxidizing atmosphere. A drying temperature is 40-150° C. such as 40° C., 60° C., 80° C., 100° C., 120° C., 140° C. or 150° C., and is further preferably 40-100° C. A drying time is 6-48 h such as 6 h, 12 h, 18 h, 24 h, 30 h, 36 h, 42 h, 46 h or 48 h, and is further preferably 6-24 h.

In a third aspect, the invention provides a lithium ion battery containing the lithium-containing silicon oxide composite anode material described in the first aspect.

### Contrastive Example 1

2 kg of SiO_{0.8} powder was weighed and placed in a CVD rotary furnace, acetylene was introduced into the CVD rotary furnace to be used as a carbon source, nitrogen was introduced into the CVD rotary furnace to be used as a protective atmosphere, deposition was carried out at 700° C. for 2.5 h, and cooling and discharging were carried out to obtain a carbon-coated silicon oxide material.

### Contrastive Example 2

2 kg of SiO_{0.8} powder was weighed and placed in a CVD rotary furnace, ethylene was introduced into the CVD rotary furnace to be used as a carbon source, nitrogen was introduced into the CVD rotary furnace to be used as a protective atmosphere, deposition was carried out at 900° C. for 3 h, and cooling and discharging were carried out to obtain a carbon-coated silicon oxide material.

### Contrastive Example 3

2 kg of SiO_{0.8} powder was weighed and placed in a CVD rotary furnace, methane was introduced into the CVD rotary furnace to be used as a carbon source, nitrogen was introduced into the CVD rotary furnace to be used as a protective atmosphere, deposition was carried out at 1000° C. for 7 h, and cooling and discharging were carried out to obtain a carbon-coated silicon oxide material.

### Contrastive Example 4

2 kg of SiO powder was weighed and evenly mixed with 800 g of saccharose in a VC mixer to obtain a mixture which was placed in a box-type furnace to be sintered for 3 h at 800° C. under a nitrogen protective atmosphere, and cooling and discharging were carried out to obtain a carbon-coated silicon oxide material.

The preparation parameters of the carbon-coated silicon oxide materials prepared in Contrastive Examples 1-4 are shown in Table 1.

TABLE 1

| | | Coating | Carbon | Carbon |
|---|---|---|---|---|
| | O/Si | method | source | content |
| Contrastive | 0.8 | gas-phase | acetylene | 2% |
| Example 1 | | | | |
| Contrastive | 0.8 | gas-phase | ethylene | 5% |
| Example 2 | | | | |
| Contrastive | 0.8 | gas-phase | methane | 10% |
| Example 3 | | | | |
| Contrastive | 1.0 | solid-phase | saccharose | 3% |
| Example 4 | | | | |

### Embodiment 1

(1) The carbon-coated silicon oxide material prepared in Contrastive Example 1 and a lithium source, namely lithium hydride, were subjected to VC mixing under a nitrogen atmosphere, wherein the mass of the lithium hydride accounted for 5% that of the carbon-coated silicon oxide material;

(2) The materials evenly mixed in Step (1) were placed in a box-type furnace and sintered at a temperature of 700° C. under an argon atmosphere, wherein the temperature rise rate was 1° C./min, and the temperature was hold for 4 h; the materials were cooled and discharged, and then dispersed and screened;

(3) The material prepared in Step (2) was soaked in water, wherein the mass ratio of the water and solid powder was 3:1; extraction filtration was carried out after the material soaked in the water was stirred at 500 rpm for 2 h; and then isopropanol was added for washing, wherein the mass ratio of the isopropanol and the solid powder was 1:1; stirring was carried out at 500 rpm for 1 h, and then extraction filtration was carried out; after that, vacuum drying and screening were carried out to obtain a lithium-containing silicon oxide composite anode material.

### Embodiment 2

(1) The carbon-coated silicon oxide material prepared in Contrastive Example 1 and a lithium source, namely lithium hydride, were subjected to VC mixing under a nitrogen atmosphere, wherein the mass of the lithium hydride accounted for 10% that of the carbon-coated silicon oxide material;

(2) The materials evenly mixed in Step (1) were placed in a box-type furnace and sintered at a temperature of 650° C. under an argon atmosphere, wherein the temperature rise rate was 1° C./min, and the temperature holding time was 4 h; the materials were cooled and discharged, and then dispersed and screened;

(3) The material prepared in Step (2) was soaked in a mixed solution of ethyl alcohol and water, wherein the mass ratio of the ethyl alcohol and the water was 1:1, and the ratio of the total mass of the solution to the mass of solid powder was 3:1; extraction filtration was carried out after the material soaked in the mixed solution was stirred at 500 rpm for 2 h; then, acetone was added for washing, wherein the mass ratio of the acetone and the solid powder was 1:1; stirring was carried out at 500 rpm for 1 h, and then extraction filtration was carried out; after that, vacuum drying and screening were carried out to obtain a lithium-containing silicon oxide composite anode material.

### Embodiment 3

(1) The carbon-coated silicon oxide material prepared in Contrastive Example 1 and a lithium source, namely lithium nitride, were subjected to VC mixing under a nitrogen atmosphere, wherein the mass of the lithium nitride accounted for 8% that of the carbon-coated silicon oxide material;

(2) The materials evenly mixed in Step (1) were placed in a box-type furnace and sintered at a temperature of 850° C. under an argon atmosphere, wherein the temperature rise rate was 1° C./min, and the holding time was 3 h; the materials were cooled and discharged, and then dispersed and screened;

(3) The material prepared in Step (2) was soaked in a mixed solution of acetic acid and water, wherein the mass ratio of the acetic acid and the water was 1:10, and the ratio of the total mass of the solution to the mass of solid powder was 3:1; extraction filtration was carried out after the material soaked in the mixed solution was stirred at 500 rpm for 2 h; then, ethyl alcohol was added for washing, wherein the mass ratio of the ethyl alcohol and the solid powder was 1:1; stirring was carried out at 500 rpm for 1 h, and then extraction filtration was carried out; after that, vacuum drying and screening were carried out to obtain a lithium-containing silicon oxide composite anode material.

### Embodiment 4

(1) The carbon-coated silicon oxide material prepared in Contrastive Example 1 and a lithium source, namely lithium metal, were mechanically blended at 180-250° C. under an argon atmosphere, wherein the mass of the lithium metal accounted for 10% that of the carbon-coated silicon oxide material;

(2) The materials evenly mixed in Step (1) were placed in a box-type furnace and sintered at a temperature of 500° C. under an argon atmosphere, wherein the temperature rise rate was 1° C./min, and the temperature was hold for 2 h; the materials were cooled and discharged, and then dispersed and screened;

(3) The material prepared in Step (2) was soaked in a mixed solution of ethyl alcohol and water, wherein the mass ratio of the ethyl alcohol and the water was 5:1, and the ratio of the total mass of the solution to the mass of solid powder was 3:1; extraction filtration was carried out after the material soaked in the mixed solution was stirred at 500 rpm for 2 h; then, diethyl ether was added for washing, wherein the mass ratio the diethyl ether and the solid powder was 1:1; stirring was carried out at 500 rpm for 1 h, and then extraction filtration was carried out; after that, vacuum drying and screening were carried out to obtain a lithium-containing silicon oxide composite anode material.

### Embodiment 5

(1) The carbon-coated silicon oxide material prepared in Contrastive Example 1 and a lithium source, namely lithium amide, were subjected to VC mixing under an argon atmosphere, wherein the mass of the lithium amide accounted for 12% that of the carbon-coated silicon oxide material;

(2) The materials evenly mixed in Step (1) were placed in a box-type furnace and sintered at a temperature of 600° C. under an argon atmosphere, wherein the temperature rise rate was 1° C./min, and the temperature holding time was 4 h; the materials were cooled and discharged, and then dispersed and screened;

(3) The material prepared in Step (2) was soaked in carbonated water, wherein the mass ratio of the carbonated water and solid powder was 3:1; extraction filtration was carried out after the material soaked in the carbonated water was stirred at 500 rpm for 2 h; then, isopropanol was added for washing, wherein the mass ratio of the isopropanol and the solid powder was 1:1; stirring was carried out at 500 rpm for 1 h, and then extraction filtration was carried out; after that, vacuum drying and screening were carried out to obtain a lithium-containing silicon oxide composite anode material.

The preparation parameters of the lithium-containing silicon oxide composite anode materials in Embodiments 1-5 of the invention are shown in Table 2.

TABLE 2

| | | | Mass ratio | | |
|---|---|---|---|---|---|
| | | | of the lithium | | |
| | | | source in the | | |
| | Carbon-coated | Lithium | carbon-coated | Washing | Washing |
| | silicon oxide | source | silicon oxide | solution A | solution B |
| Embodiment 1 | Contrastive | LiH | 5% | water | isopropanol |
| | Example 1 | | | | |
| Embodiment 2 | Contrastive | LiH | 10% | ethyl alcohol | acetone |
| | Example 1 | | | and water | |
| Embodiment 3 | Contrastive | Li₃N | 8% | acetic acid | ethyl alcohol |
| | Example 1 | | | and water | |
| Embodiment 4 | Contrastive | Li | 10% | ethyl alcohol | diethyl ether |
| | Example 1 | | | and water | |
| Embodiment 5 | Contrastive | LiNH₂ | 12% | carbonated | isopropanol |
| | Example 1 | | | water | |

The raw materials and operation process in Embodiments 6-10 were respectively the same as those in Embodiments 1-5 except that the carbon-coated silicon oxide material in Embodiments 6-10 were the sample prepared in Contrastive Example 2.

The raw materials and operation process in Embodiments 11-15 were respectively the same as those in Embodiments 1-5 except that the carbon-coated silicon oxide material in Embodiments 11-15 were the sample prepared in Contrastive Example 3.

The raw materials and operation process in Embodiments 16-20 were respectively the same as those in Embodiments 1-5 except that the carbon-coated silicon oxide material in Embodiments 16-20 were the sample prepared in Contrastive Example 4.

Test results of the electrochemical properties of the materials in the contrastive examples and embodiments are shown in Table 3. As can be seen from Table 3, the initial reversible capacity of the lithium-containing silicon oxide composite anode material may reach 1600 mAh/g, the initial coulombic efficiency may reach over 91.0%, and the capacity retention rate after 50 cycles may reach 98%.

TABLE 3

| | Initial charging | | Capacity retention |
|---|---|---|---|
| | specific capacity | Initial coulombic | rate after 50 |
| | (mAh/g) | efficiency (%) | cycles (%) |
| Contrastive | 1650 | 65.2 | 50 |
| Example 1 | | | |
| Contrastive | 1630 | 67.1 | 52 |
| Example 2 | | | |
| Contrastive | 1625 | 70.6 | 61 |
| Example 3 | | | |
| Contrastive | 1628 | 66.7 | 55 |
| Example 4 | | | |
| Embodiment 1 | 1604 | 91.2 | 97.2 |
| Embodiment 2 | 1603 | 91.7 | 97.5 |
| Embodiment 3 | 1602 | 91.3 | 98.1 |
| Embodiment 4 | 1601 | 93.0 | 97.7 |
| Embodiment 5 | 1609 | 92.4 | 97.9 |
| Embodiment 6 | 1604 | 91.0 | 97.2 |
| Embodiment 7 | 1605 | 91.3 | 97.7 |
| Embodiment 8 | 1602 | 91.3 | 97.1 |
| Embodiment 9 | 1602 | 92.1 | 97.7 |
| Embodiment 10 | 1600 | 91.6 | 98.0 |
| Embodiment 11 | 1604 | 91.0 | 97.5 |
| Embodiment 12 | 1605 | 92.0 | 97.3 |
| Embodiment 13 | 1602 | 91.3 | 98.0 |
| Embodiment 14 | 1602 | 92.0 | 97.3 |
| Embodiment 15 | 1600 | 92.2 | 97.6 |
| Embodiment 16 | 1601 | 91.0 | 97.6 |
| Embodiment 17 | 1603 | 91.5 | 97.5 |
| Embodiment 18 | 1606 | 91.3 | 98.0 |
| Embodiment 19 | 1605 | 91.7 | 97.4 |
| Embodiment 20 | 1602 | 92.1 | 98.2 |

Test Method

1. Crystal structure characterization: the crystal structure of the lithium-containing silicon oxide composite anode materials prepared in the embodiments and the contrastive examples was characterized. A powder diffractometer Xpert3 Powder of PANalytical in Holland was used for XRD tests, the test voltage was 40 KV, the test current was 40 mA, the scan range was 10°-90°, the scan step was 0.008°, and the time of each step of scan was 12 s.

The average grain size of Si in the material was characterized by an X-ray diffractometer, scanning was carried out within 10°-90° of 2θ, then fitting was carried out within 26°-30° of 2θ to obtain a half-peak width of a Si(111) peak, and finally, the average grain size of Si grains was calculated according to the Scherrer formula.

The diffraction peak area of Li₂SiO₃(111) with 2θ being 26.90±0.3° in an XRD spectrum was A1, the diffraction peak area of Si(111) with 2θ being 28.40±0.3° in the XRD spectrum was A2, and the ratio of A2 to A1 was calculated.

The diffraction peak intensity of Li₂Si₂O₅(111) with 2θ being 24.75±0.2° in the XRD spectrum was I1, the diffraction peak intensity of Li₂SiO₃(111) with 2θ being 26.90±0.3° in the XRD spectrum was I2, and the ratio of I1 to I2 was calculated.

2. Test of the first charge-discharge performance of button batteries: the lithium-containing silicon oxide composite anode materials prepared in the embodiments and the contrastive examples were used as active substances to be mixed with a binder, namely an aqueous dispersion of a acrylonitrile multipolymer (LA132, solid content 15%), and a conductive agent (Super-P) according to a mass ratio of 70:10:20, a proper amount of water was added to be used as a solvent to prepare paste, and the paste was smeared on a copper foil, dried in vacuum and rolled to prepare anodes; with lithium metal as a counter electrode, CR2032 button batteries were assembled in a glove box filled with an inert gas with polypropylene microporous membranes as membranes, by means of 1 mol/L of an electrolyte which was a LiPF₆ three-component mixed solvent mixed according to EC:DMC:EMC=1:1:1(v/v). The charge-discharge performance of the button batteries was tested by means of a battery test system of LANHE. Specifically, under a normal temperature, the button batteries were charged and discharged to 0.01V at a constant current of 0.1 C, then discharged to 0.005V at a constant current of 0.02 C, and finally charged to 1.5V at a constant current of 0.1 C; and the capacity obtained when the button batteries were charged to 1.5V was the first reversible capacity, and the ratio of the charge capacity to the discharge capacity is the first coulombic efficiency.

3. Test of the cycle performance: the lithium-containing silicon oxide composite anode materials prepared in the embodiments and the contrastive examples were evenly mixed with graphite according to the mass ratio of 1:9 and then used as active substances to be mixed with a binder, namely an aqueous dispersion of a acrylonitrile multipolymer (LA132, solid content 15%), and a conductive agent (Super-P) according to a mass ratio of 70:10:20, a proper amount of water was added to be used as a solvent to prepare paste, and the paste was smeared on copper foil, dried in vacuum and rolled to prepare anodes; with lithium metal as a counter electrode, CR2032 button batteries were assembled in a glove box filled with an inert gas with polypropylene microporous membranes as membranes, by means of 1 mol/L of an electrolyte which was a LiPF₆ three-component mixed solvent mixed according to EC:DMC:EMC=1:1:1(v/v). The charge-discharge performance of the button batteries was tested by means of a battery test system of LANHE. Specifically, under a normal temperature, the button batteries were charged and discharged at a constant current of 0.1 C, and the charge-discharge voltage was limited to 0.005-1.5V. The capacity retention rate after 50 cycles was the ratio of the charge capacity of the fiftieth cycle to the charge capacity of the first cycle.

The above embodiments only express several implementations of the invention and are specifically described in detail, but should not be construed as limitations of the scope of the patent of invention. It should be noted that those ordinarily skilled in the art can make different transformations and improvements without departing from the concept of the invention, and all these transformations and improvements fall within the protection scope of the invention. Thus, the protection scope of the patent of invention should be subject the appended claims.

What is claimed is:

1. A lithium-containing silicon oxide composite anode material, wherein the lithium-containing silicon oxide composite anode material has a core-shell structure which comprises a core and a shell, the core comprises nano-silicon, Li₂SiO₃ and Li₂Si₂O₅, and the shell is a conductive carbon layer wrapping the core.

2. The lithium-containing silicon oxide composite anode material according to claim 1, wherein an average grain size of the nano-silicon is less than or equal to 20 nm.

3. The lithium-containing silicon oxide composite anode material according to claim 1, wherein a thickness of the conductive carbon layer is 2-500 nm.

4. The lithium-containing silicon oxide composite anode material according to claim 1, wherein a diffraction peak area of Li₂SiO₃(111) with 2θ being 26.90±0.3° in an XRD spectrum of the lithium-containing silicon oxide composite anode material is A1, and a diffraction peak area of Si(111) with 2θ being 28.40±0.3° in the XRD spectrum is A2; and A2/A1≥1.0.

5. The lithium-containing silicon oxide composite anode material according to claim 1, wherein a diffraction peak intensity of Li₂Si₂O₅(111) with 2θ being 24.75±0.2° in an XRD spectrum of the lithium-containing silicon oxide composite anode material is I1, a diffraction peak intensity of Li₂SiO₃(111) with 2θ being 26.90±0.3° in the XRD spectrum is I2; and 0.25≤I1/I2≤1.0.

6. A method for preparing a lithium-containing silicon oxide composite anode material, comprising:
(1) mixing a carbon-coated silicon oxide SiOₓ with a lithium source by a solid-phase mixing method to form a pre-lithiated precursor;
(2) carrying out heat treatment on the pre-lithiated precursor under a vacuum or non-oxidizing atmosphere, and then dispersing and screening the pre-lithiated precursor to realize phase and structure adjustment to form a compound; and
(3) carrying out surface modification on the compound formed in Step (2) to obtain a surface-treated lithium-containing silicon oxide composite anode material.

7. The method for preparing a lithium-containing silicon oxide composite anode material according to claim 6, wherein in the carbon-coated silicon oxide SiOx, 0.5≤x≤1.6.

8. The method for preparing a lithium-containing silicon oxide composite anode material according to claim 6, wherein carbon coating of the carbon-coated silicon oxide SiOₓ is any one of gas-phase coating and solid-phase coating.

9. The method for preparing a lithium-containing silicon oxide composite anode material according to claim 6, wherein in Step (3), the surface modification is washing which comprises:
soaking the compound prepared in Step (2) in a solution A;
carrying out solid-phase separation after the compound is soaked in the solution A to obtain a solid;
washing the solid with a solution B after solid-liquid separation; and
drying the solid;
wherein the solution A is any one of alcohol, alkaline water dissolved with lithium carbonate, weak acid, water, and a mixed solution thereof, and the solution B is any one of an ether solvent, a ketone solution, a lipid solution, an alcohol solvent, an amine solvent, and a mixed solvent thereof.

10. A lithium ion battery, containing the lithium-containing silicon oxide composite anode material of claim 1.
